(19) United States
(12) Patent Application Publication
(10) Pub. No.: US 2014/0170380 A1
(43) Pub. Date: Jun. 19, 2014

(54) TEMPERED GLASS AND METHOD FOR PRODUCING SAME

(71) Applicants: Takashi Murata, Shiga (JP); Takako Tojyo, Shiga (JP)

(72) Inventors: Takashi Murata, Shiga (JP); Takako Tojyo, Shiga (JP)

(21) Appl. No.: 14/239,808

(22) PCT Filed: Aug. 17, 2012
(86) PCT No.: PCT/JP2012/070921

§ 371 Date: Feb. 20, 2014

(30) Foreign Application Priority Data
Aug. 23, 2011 (JP) 2011-181807

(51) Int. Cl. C03C 3/11; C03C 3/097; C03C 21/00; C03B 33/02; C03C 15/00

(52) U.S. Cl. CPC C03C 3/11; C03B 33/02; C03C 15/00; C03C 21/002; C03C 3/097
USPC 428/141; 428/410; 65/30.14

(57) ABSTRACT

A tempered glass of the present invention is a tempered glass having a compression stress layer in a surface thereof, the tempered glass comprising, as a glass composition in terms of mol %, 45 to 75% of SiO₂, 3 to 15% of Al₂O₃, 0 to 12% of Li₂O, 0.3 to 20% of Na₂O, 0 to 10% of K₂O, and 1 to 15% of MgO+CaO, and having a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5, characterized in that the surface or an end surface of the tempered glass is etched after tempering treatment.

### TECHNICAL FIELD

The present invention relates to a tempered glass and a production method for the same, and more particularly, to a tempered glass suitable for a cover glass for a cellular phone, a digital camera, a personal digital assistant (PDA), or a solar cell, or a glass substrate for a display, in particular, a touch panel display, and a production method for the same.

### BACKGROUND ART

Devices such as a cellular phone, a digital camera, a PDA, a touch panel display, a large-screen television, and a wireless charging system tend to be more widely used.

A tempered glass produced by performing tempering treatment such as ion exchange treatment is used in each of those devices (see Patent Literature 1 and Non Patent Literature 1).

In conventional devices, there has been adopted a structure in which a touch panel sensor is formed on a display module and a tempered glass (protective member) is placed over the touch panel sensor.

Further, although small devices such as a cellular phone each have a size of 3 to 4 inches, tablet PCs and the like each have a size of 9 to 10 inches. Thus, such devices as the tablet PCs each involve the issues of how to reduce the mass of the device and how to reduce the total thickness thereof.

In order to cope with those issues, a method involving forming a touch panel sensor on a tempered glass (protective member) has been adopted. In this case, the tempered glass (protective member) is required to, for example, (1) have a high mechanical strength, (2) have a liquidus viscosity suitable for, for example, a down-draw method such as an overflow down-draw method or a slit down-draw method and a float method, in order to perform the mass production of large glass sheets, (3) have a viscosity at high temperature suitable for being formed into a shape, (4) have a low density, and (5) have a sufficiently high strain point to prevent pattern shift from occurring at the time of forming a tough panel film.

### CITATION LIST

### Patent Literature

Patent Literature 1: JP 2006-83045 A

### Non Patent Literature

Non Patent Literature 1: Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

By the way, when patterning is performed individually onto each tempered glass having a size of 3 to 10 inches, the production cost of a device using the tempered glass increases. In order to cope with this problem, it is possible to adopt a method involving performing a predetermined patterning onto a large tempered glass and then cutting the large one into a plurality of small tempered glass pieces with a laser.

However, this method involves a problem in that, when an R process is applied to the four corners of each resultant laser-cut tempered glass, or a notching process is applied to each long side thereof or each short side thereof, the production cost of a device using the tempered glass increases. When such a tempered glass is used for applications such as a mobile terminal, this problem is particularly serious.

On the other hand, when a large glass sheet is subjected to tempering treatment, and a predetermined patterning and masking are applied to the tempered glass sheet, and then etching in an etching liquid is performed to separate the resultant into a plurality of small tempered glass pieces, the above-mentioned problem can be solved. However, it took a long time to apply etching to conventional tempered glasses, possibly increasing the cost of each resultant small tempered glass piece.

Thus, a technical object of the present invention is to invent a tempered glass which satisfies the characteristics conventionally required and can be easily separated into a plurality of small tempered glass pieces by etching.

### Solution to Problem

The inventors of the present invention have made various studies and have consequently found that the technical object can be achieved by strictly controlling the content range of each component in a glass composition and etching the surface of glass after tempering treatment. Thus, the finding is proposed as the present invention. That is, a tempered glass of the present invention is a tempered glass having a compression stress layer in a surface thereof, the tempered glass comprising, as a glass composition in terms of mol %, 45 to 75% of SiO₂, 3 to 15% of Al₂O₃, 0 to 12% of B₂O₃, 0 to 12% of Li₂O, 0.3 to 20% of Na₂O, 0 to 10% of K₂O, 1 to 15% of MgO+CaO, and 0 to 10% of P₂O₅, and having a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5, characterized in that the surface or an end surface of the tempered glass is etched after tempering treatment. Herein, the “MgO+CaO” refers to the total amount of MgO and CaO. The “Al₂O₃+Na₂O+P₂O₅” refers to the total amount of Al₂O₃, Na₂O, and P₂O₅. The “B₂O₃+Na₂O” refers to the total amount of B₂O₃ and Na₂O, Note that, although the aspect that the surfaces of the tempered glass (or small pieces thereof) of the present invention are entirely etched is not completely excluded, the aspect that the surfaces of the tempered glass (or small pieces thereof) are partially etched or the aspect that the surfaces thereof are not etched is preferred, when the gist of the present invention is taken into consideration. Further, when the tempered glass of the present invention is separated into small tempered glass pieces each having a product shape by etching, the end surfaces of the tempered glass usually are entirely etched.

Second, it is preferred that the tempered glass of the present invention comprise, as a glass composition in terms of mol %, 45 to 75% of SiO₂, 4 to 13% of Al₂O₃, 0 to 3% of B₂O₃, 0 to 8% of Li₂O, 5 to 20% of Na₂O, 0.1 to 10% of K₂O, 3 to 13% of MgO+CaO, and 0 to 10% of P₂O₅, and have a molar ratio (Al₂O₃+Na₂O+P₂O₅)/SiO₂ of 0.1 to 0.7, a molar ratio (B₂O₃+Na₂O)/SiO₂ of 0.1 to 0.7, a molar ratio P₂O₅/SiO₂ of 0 to 0.5, a molar ratio Al₂O₃/SiO₂ of 0.01 to 0.7, and a molar ratio Na₂O/Al₂O₃ of 0.5 to 4.

Third, it is preferred that the tempered glass of the present invention comprise, as a glass composition in terms of mol %, 45 to 75% of SiO₂, 5 to 12% of Al₂O₃, 0 to 1% of B₂O₃, 0 to 4% of Li₂O, 8 to 20% of Na₂O, 0.5 to 10% of K₂O, 5 to 13% of MgO+CaO, and 0 to 10% of P₂O₅, and have a molar ratio (Al₂O₃+Na₂O+P₂O₅)/SiO₂ of 0.1 to 0.5, a molar ratio (B₂O₃+Na₂O)/SiO₂ of 0.1 to 0.5, a molar ratio P₂O₅/SiO₂ of 0 to 0.3, a molar ratio Al₂O₃/SiO₂ of 0.05 to 0.5, and a molar ratio Na₂O/Al₂O₃ of 1 to 3.

Fourth, it is preferred that the tempered glass of the present invention comprise, as a glass composition in terms of mol %, 45 to 75% of SiO₂, 5 to 11% of Al₂O₃, 0 to 1% of B₂O₃, 0 to 4% of Li₂O, 9 to 20% of Na₂O, 0.5 to 8% of K₂O, 0 to 12% of MgO, 0 to 3% of CaO, 5 to 12% of MgO+CaO, and 0 to 10% of P₂O₅, and have a molar ratio (Al₂O₃+Na₂O+P₂O₅)/SiO₂ of 0.1 to 0.5, a molar ratio (B₂O₃+Na₂O)/SiO₂ of 0.1 to 0.3, a molar ratio P₂O₅/SiO₂ of 0 to 0.2, a molar ratio Al₂O₃/SiO₂ of 0.05 to 0.3, and a molar ratio Na₂O/Al₂O₃ of 1 to 3.

Fifth, it is preferred that the tempered glass of the present invention comprise, as a glass composition in terms of mol %, 50 to 70% of SiO₂, 5 to 11% of Al₂O₃, 0 to 1% of B₂O₃, 0 to 2% of Li₂O, 10 to 18% of Na₂₀, 1 to 6% of K₂O, 0 to 12% of MgO, 0 to 2.5% of CaO, 5 to 12% of MgO+CaO, and 0 to 10% of P₂O₅, and have a molar ratio (Al₂O₃+Na₂O+P₂O₅)/SiO₂ of 0.2 to 0.5, a molar ratio (B₂O₃+Na₂O)/SiO₂ of 0.15 to 0.27, a molar ratio P₂O₅/SiO₂ of 0 to 0.1, a molar ratio Al₂O₃/SiO₂ of 0.07 to 0.2, and a molar ratio Na₂O/Al₂O₃ of 1 to 2.3.

Sixth, in the tempered glass of the present invention, it is preferred that a surface roughness Ra of the etched surface be 1 nm or less. Herein, the “surface roughness Ra” refers to a value obtained by a measurement method in accordance with SEMI D7-94 “FPD glass substrate surface roughness measurement method.”

Seventh, in the tempered glass of the present invention, it is preferred that a compression stress value of the compression stress layer be 200 MPa or more, and a depth of the compression stress layer be 10 μm or more. Herein, the “compression stress value of the compression stress layer” and the “depth of the compression stress layer” refer to values which are calculated from the number of interference fringes on a sample and each interval between the interference fringes, the interference fringes being observed when a surface stress meter (such as FSM-6000 manufactured by Toshiba Corporation) is used to observe the sample.

Eighth, it is preferred that the tempered glass of the present invention have an internal tensile stress of 1 to 200 MPa. Herein, the “internal tensile stress” is calculated from the following equation.

Internal tensile stress=(compression stress value×depth of compression stress layer)/(sheet thickness−depth of compression stress layer×2)

Ninth, it is preferred that the tempered glass of the present invention have a liquidus temperature of 1,250° C. or less. Herein, the “liquidus temperature” refers to a temperature at which crystals of glass are deposited after glass powder that passes through a standard 30-mesh sieve (sieve opening: 500 μm) and remains on a 50-mesh sieve (sieve opening: 300 μm) is placed in a platinum boat and then kept for 24 hours in a gradient heating furnace.

Tenth, it is preferred that the tempered glass of the present invention have a liquidus viscosity of 10^{4.0} dPa·s or more. Herein, the “liquidus viscosity” refers to a value obtained through measurement of a viscosity of glass at the liquidus temperature by a platinum sphere pull up method.

Eleventh, it is preferred that the tempered glass of the present invention have a temperature at 10^{4.0} dPa·s of 1,280° C. or less. Herein, the “temperature at 10^{4.0} dPa·s” refers to a value obtained through measurement by a platinum sphere pull up method.

Twelfth, it is preferred that the tempered glass of the present invention have a temperature at 10^{2.5} dPa·s of 1,620° C. or less. Herein, the “temperature at 10^{2.5} dPa·s” refers to a value obtained through measurement by a platinum sphere pull up method.

Thirteenth, it is preferred that the tempered glass of the present invention have a density of 2.6 g/cm³ or less. Herein, the “density” can be measured by a well-known Archimedes method.

Fourteenth, it is preferred that the tempered glass of the present invention be formed by a float method.

Fifteenth, it is preferred that the tempered glass of the present invention be used for a touch panel display.

Sixteenth, it is preferred that the tempered glass of the present invention be used for a cover glass for a cellular phone.

Seventeenth, it is preferred that the tempered glass of the present invention be used for a cover glass for a solar cell.

Eighteenth, it is preferred that the tempered glass of the present invention be used for a protective member for a display.

Nineteenth, a production method for a tempered glass of the present invention is characterized by comprising: (1) a forming step of melting glass raw materials blended so as to achieve a glass composition comprising, in terms of mol %, 45 to 75% of SiO₂, 3 to 15% of Al₂O₃, 0 to 12% of Li₂O, 0.3 to 20% of Na₂O, 0 to 10% of K₂O, and 1 to 15% of MgO+CaO, followed by the formation of the molten glass into a glass sheet; (2) a tempering step of forming a compression stress layer by performing ion exchange treatment to yield a tempered glass; (3) a masking step of masking a surface of the tempered glass; and (4) an etching step of etching the tempered glass in an etching liquid.

Twentieth, it is preferred that the production method for a tempered glass of the present invention comprise a patterning step of performing patterning on the surface of the tempered glass before the masking step. With this, the production cost of a device using the tempered glass significantly reduces. In this case, it is preferred that masking be also performed on the surface of a predetermined pattern formed on the surface of the tempered glass in order to prevent the degradation of the pattern caused by the subsequent etching.

Twenty-first, in the production method for a tempered glass of the present invention, it is preferred that the etching step be a step of separating the tempered glass into a plurality of small tempered glass pieces. With this, a plurality of tempered glasses each having a product shape can be produced from a large tempered glass, and hence the production cost of devices using such tempered glasses significantly reduces.

Twenty-second, in the production method for a tempered glass of the present invention, it is preferred that the etching liquid comprise one kind or two or more kinds selected from the group consisting of HF, HCl, H₂SO₄, HNO₃, NH₄F, NaOH, and NH₄HF₂. Note that those etching liquids each have good performance for etching.

### Advantageous Effects of Invention

The tempered glass of the present invention has the property of being etched properly, and hence etching for a short time can remove the parts excluding masked parts. As a result, each shape necessary to be used in a cellular phone, a tablet PC, and the like can be efficiently provided to each of the masked parts, and the masked parts can each have high surface quality and high end surface quality. In addition, the tempered glass of the present invention has high ion exchange performance, thus having a high mechanical strength and having a variation in mechanical strength to a small extent. Further, the tempered glass of the present invention has a low density, enabling production of a lighter tablet PC, and has a high strain point, thus being able to undergo a high-quality patterning.

### BRIEF DESCRIPTION OF DRAWINGS

FIG. 1A is a conceptual diagram for describing the experimental procedure in Example 2 of the present invention.

FIG. 1B is a conceptual diagram for further describing the experimental procedure in Example 2 of the present invention.

FIG. 1C is a conceptual diagram for further describing the experimental procedure in Example 2 of the present invention.

### DESCRIPTION OF EMBODIMENTS

(1) Tempered Glass

A tempered glass according to an embodiment of the present invention has a compression stress layer in a surface thereof. Although a physical tempering method may be used as a method of forming the compression stress layer in the surface, a chemical tempering method is more preferably used. The chemical tempering method is a method involving introducing alkali ions each having a large ion radius into the surface layer of glass by ion exchange treatment at a temperature equal to or lower than a strain point of the glass. When the chemical tempering method is used to form a compression stress layer, the compression stress layer can be properly formed even in the case where the thickness of the glass is small. In addition, even when a tempered glass is cut after the formation of the compression stress layer, the tempered glass does not easily break unlike a tempered glass produced by applying a physical tempering method such as an air cooling tempering method.

The tempered glass of this embodiment comprises, as a glass composition in terms of mol %, 45 to 75% of SiO₂, 3 to 15% of Al₂O₃, 0 to 12% of B₂O₃, 0 to 12% of Li₂O, 0.3 to 20% of Na₂O, 0 to 10% of K₂O, 1 to 15% of MgO+CaO, and 0 to 10% of P₂O₅. The reason why the content range of each component is limited as described above is described below. Note that, unless specifically indicated, the expression “%” refers to “mol %” in the following description of the content range of each component.

SiO₂ is a component that forms a network of glass. The content of SiO₂ is 45 to 75%, preferably 50 to 70%, 55 to 68%, 55 to 67%, particularly preferably 58 to 66%. When the content of SiO₂ is too small, vitrification does not occur easily, the thermal expansion coefficient becomes too high, the thermal shock resistance is liable to lower, and the rate of etching with an acid such as HCl becomes too high, with the result that it is difficult to obtain desired surface quality and desired end surface quality. On the other hand, when the content of SiO₂ is too large, the meltability and formability are liable to lower, and the thermal expansion coefficient becomes too low, with the result that it is difficult to match the thermal expansion coefficient with those of peripheral materials. In addition, the rate of etching becomes low and hence the productivity of a device using the tempered glass is liable to lower.

Al₂O₃ is a component that enhances the ion exchange performance and is a component that enhances the strain point or Young's modulus. The content of Al₂O₃ is 3 to 15%. When the content of Al₂O₃ is too small, the ion exchange performance may not be exerted sufficiently. Thus, the lower limit range of Al₂O₃ is suitably 4% or more, 5% or more, 5.5% or more, 7% or more, 8% or more, particularly suitably 9% or more. On the other hand, when the content of Al₂O₃ is too large, devitrified crystals are liable to be deposited in the glass, and it is difficult to form a glass sheet by a float method, an overflow down-draw method, or the like. Further, the thermal expansion coefficient becomes too low, and it is difficult to match the thermal expansion coefficient with those of peripheral materials. In addition, the viscosity at high temperature increases and the meltability is liable to lower. In addition, the rate of etching with an acid such as HCl becomes too high, and hence the glass is difficult to have desired surface quality and desired end surface quality. Thus, the upper limit range of Al₂O₃ is suitably 13% or less, 12% or less, 11% or less, particularly suitably 9% or less.

B₂O₃ is a component that lowers the viscosity at high temperature and density, stabilizes glass so that a crystal may be unlikely precipitated, and lowers the liquidus temperature. However, when the content of B₂O₃ is too large, through ion exchange, coloring on the surface of glass called weathering occurs, water resistance lowers, the compression stress value of the compression stress layer lowers, the depth of the compression stress layer decreases, and the rate of etching with an acid such as HCl becomes too high, with the result that the glass is difficult to have desired surface quality and desired end surface quality. Thus, the content of B₂O₃ is preferably 0 to 12%, 0 to 5%, 0 to 3%, 0 to 1.5%, 0 to 1%, 0 to 0.9%, 0 to 0.5%, particularly preferably 0 to 0.1%.

Li₂O is an ion exchange component, is a component that lowers the viscosity at high temperature to increase the meltability and formability, and is a component that increases the Young's modulus. Further, Li₂O has a great effect of increasing the compression stress value among alkali metal oxides, but when the content of Li₂O becomes extremely large in a glass system containing Na₂O at 5% or more, the compression stress value tends to lower to the worse. Further, when the content of Li₂O is too large, the liquidus viscosity lowers, the glass is liable to denitrify, and the thermal expansion coefficient becomes too high, with the result that the thermal shock resistance lowers and it is difficult to match the thermal expansion coefficient with those of peripheral materials. In addition, the viscosity at low temperature becomes too low, and the stress relaxation is liable to occur, with the result that the compression stress value lowers to the worse in some cases. Thus, the content of Li₂O is 0 to 12%, preferably 0 to 8%, 0 to 4%, 0 to 2%, 0 to 1%, 0 to 0.5%, 0 to 0.3%, particularly preferably 0 to 0.1%.

Na₂O is an ion exchange component and is a component that lowers the viscosity at high temperature to increase the meltability and formability. Na₂O is also a component that improves the denitrification resistance. The content of Na₂O is 0.3 to 20%. When the content of Na₂O is too small, the meltability lowers, the thermal expansion coefficient lowers, and the ion exchange performance is liable to lower. In addition, the rate of etching is low and hence the productivity of the device is liable to lower. Thus, the lower limit range of Na₂O is suitably 5% or more, 8% or more, 9% or more, 10% or more, 11% or more, particularly suitably 12% or more. On the other hand, when the content of Na₂O is too high, the thermal expansion coefficient becomes too large, the thermal shock resistance lowers, and it is difficult to match the thermal expansion coefficient with those of peripheral materials. Further, the strain point lowers excessively, and the glass composition loses its component balance, with the result that the devitrification resistance lowers to the worse in some cases. In addition, the rate of etching with an acid such as HCl is too high, and hence the glass is difficult to have desired surface quality and desired end surface quality. Thus, the upper limit range of Na₂O is suitably 19% or less, 18% or less, 17% or less, particularly suitably 16% or less.

K₂O is a component that promotes ion exchange and is a component that allows the depth of the compression stress layer to be easily increased among alkali metal oxides. K₂O is also a component that lowers the viscosity at high temperature to increase the meltability and formability. K₂O is also a component that improves devitrification resistance. Thus, the content of K₂O is 0 to 10%. When the content of K₂O is too high, the thermal expansion coefficient becomes too large, the thermal shock resistance lowers, and it is difficult to match the thermal expansion coefficient with those of peripheral materials. Further, the strain point lowers excessively, and the glass composition loses its component balance, with the result that the devitrification resistance tends to lower to the worse. Thus, the upper limit range of K₂O is suitably 8% or less, 7% or less, 6% or less, particularly suitably 5% or less. Note that, when K₂O is added to the glass composition, the lower limit range of K₂O is suitably 0.1% or more, 0.5% or more, 1% or more, 1.5% or more, 2% or more, particularly suitably 2.5% or more.

The content of Li₂O+Na₂O+K₂O is preferably 5 to 25%, 8 to 22%, 12 to 20%, particularly preferably 16.5 to 20%. When the content of Li₂O+Na₂O+K₂O is too small, the ion exchange performance and meltability are liable to deteriorate. On the other hand, when the content of Li₂O+Na₂O+K₂O is too large, the glass is liable to denitrify and the thermal expansion coefficient increases excessively, with the result that the thermal shock resistance deteriorates and it is difficult to match the thermal expansion coefficient with those of peripheral materials. In addition, the strain point lowers excessively, with the result that a high compression stress value is hardly achieved in some cases. Moreover, the viscosity at around its liquidus temperature lowers, with the result that the glass is difficult to have a high liquidus viscosity in some cases. Note that the “Li₂O+Na₂O+K₂O” refers to the total amount of Li₂O, Na₂O, and K₂O.

MgO is a component that reduces the viscosity at high temperature to enhance the meltability and formability, and increases the strain point and Young's modulus, and is a component that has a great effect of enhancing the ion exchange performance among alkaline earth metal oxides. However, when the content of MgO is too large, the density and thermal expansion coefficient increase, and the glass is liable to devitrify. Thus, the upper limit range of MgO is suitably 12% or less, 10% or less, 8% or less, particularly suitably 7% or less. Note that, when MgO is added to the glass composition, the lower limit range of MgO is suitably 0.1% or more, 0.5% or more, 1% or more, 2% or more, particularly suitably 3% or more.

CaO is a component that has great effects of reducing the viscosity at high temperature to enhance the meltability and formability, and increasing the strain point and Young's modulus without causing any reduction in devitrification resistance as compared to other components. The content of CaO is preferably 0 to 10%. However, when the content of CaO is too large, the density and thermal expansion coefficient increase, and the glass composition loses its component balance, with the results that the glass is liable to devitrify to the worse, the ion exchange performance is liable to lower, and phase separation is liable to occur. Thus, the content of CaO is suitably 0 to 5%, 0 to 3%, particularly suitably 0 to 2.5%.

The content of MgO+CaO is 1 to 15%. When the content of MgO+CaO is too small, the glass is difficult to have desired ion exchange performance, the viscosity at high temperature increases, and the melting temperature is liable to increase. On the other hand, when the content of MgO+CaO is too large, the density and thermal expansion coefficient increase, and the devitrification resistance is liable to deteriorate. Thus, the content of MgO+CaO is preferably 3 to 13%, 5 to 13%, 5 to 12%, particularly preferably 5 to 11%.

P₂O₅ is a component that enhances the ion exchange performance and a component that increases the depth of the compression stress layer, in particular. However, when the content of P₂O₅ is too large, phase separation occurs in the glass, the rate of etching with an acid such as HCl is too high, and hence the glass is difficult to have desired surface quality and desired end surface quality. Thus, the upper limit range of P₂O₅ is suitably 10% or less, 5% or less, particularly suitably 3% or less. Note that, when P₂O₅ is added to the glass composition, the lower limit range of P₂O₅ is suitably 0% or more, 0.01% or more, 0.1% or more, 0.5% or more, particularly suitably 1% or more.

The tempered glass of this embodiment preferably has the following component ratios.

A molar ratio (Al₂O₃+Na₂O+P₂O₅)/SiO₂ is 0.1 to 1. When the molar ratio (Al₂O₃+Na₂O+P₂O₅)/SiO₂ is too small, the rate of etching is low and hence the productivity of the device is liable to lower. In addition, the ion exchange performance is liable to deteriorate. On the other hand, when the molar ratio (Al₂O₃+Na₂O+P₂O₅)/SiO₂ is too large, the rate of etching with an acid such as HCl is too high, and hence the glass is difficult to have desired surface quality and desired end surface quality, the denitrification resistance deteriorates, and the glass is difficult to have a high liquidus viscosity. Thus, the lower limit range of the molar ratio (Al₂O₃+Na₂O+P₂O₅)/SiO₂ is suitably 0.15 or more, 0.2 or more, particularly suitably 0.25 or more, and the upper limit range thereof is suitably 0.7 or less, 0.5 or less, particularly suitably 0.4 or less.

A molar ratio (B₂O₃+Na₂O)/SiO₂ is 0.1 to 1. When the molar ratio (B₂O₃+Na₂O)/SiO₂ is too small, the rate of etching is low and hence the productivity of the device is liable to lower. In addition, the viscosity at high temperature increases, and hence the meltability deteriorates, with the result that the bubble quality is liable to deteriorate. On the other hand, when the molar ratio (B₂O₃+Na₂O)/SiO₂ is too large, the rate of etching with an acid such as HCl is too high, and hence the glass is difficult to have desired surface quality and desired end surface quality, the denitrification resistance deteriorates, and the glass is difficult to have a high liquidus viscosity. Thus, the lower limit range of the molar ratio (B₂O₃+Na₂O)/SiO₂ is suitably 0.15 or more, 0.2 or more, particularly suitably 0.23 or more, and the upper limit range thereof is suitably 0.7 or less, 0.5 or less, 0.4 or less, 0.3 or less, particularly suitably 0.27 or less.

A molar ratio P₂O₅/SiO₂ is 0 to 1. When the molar ratio P₂O₅/SiO₂ is large, the compression stress layer tends to have a large thickness. However, when the value of the molar ratio is too large, the rate of etching with an acid such as HCl is too high, and hence the glass is difficult to have desired surface quality and desired end surface quality. Thus, the range of the molar ratio P₂O₅/SiO₂ is suitably 0 to 0.5, 0 to 0.3, 0 to 0.2, particularly suitably 0 to 0.1.

A molar ratio Al₂O₃/SiO₂ is 0.01 to 1. When the molar ratio Al₂O₃/SiO₂ is larger, the strain point and Young's modulus increase, and the ion exchange performance can be enhanced. However, when the value of the molar ratio is too large, devitrified crystals are liable to be deposited in the glass, the glass is difficult to have a high liquidus viscosity, the viscosity at high temperature increases, the meltability is liable to deteriorate, the rate of etching with an acid such as HCl is too high, and hence the glass is difficult to have desired surface quality and desired end surface quality. Thus, the range of the molar ratio Al₂O₃/SiO₂ is suitably 0.01 to 0.7, 0.01 to 0.5, 0.05 to 0.3, particularly suitably 0.07 to 0.2.

A molar ratio Na₂O/Al₂O₃ is 0.1 to 5. When the molar ratio Na₂O/Al₂O₃ is too small, the denitrification resistance is liable to deteriorate and the melting temperature is liable to increase. On the other hand, when the molar ratio Na₂O/Al₂O₃ is too large, the thermal expansion coefficient becomes too high, the viscosity at high temperature becomes too low, and hence the glass is difficult to have a high liquidus viscosity. Thus, the range of the molar ratio Na₂O/Al₂O₃ is suitably 0.5 to 4, 1 to 3, particularly suitably 1.2 to 2.3.

In addition to the components described above, for example, the following components may be added.

SrO is a component that reduces the viscosity at high temperature to increase the meltability and formability, and increases the strain point and Young's modulus without causing any reduction in devitrification resistance. When the content of SrO is too large, the density and thermal expansion coefficient increase, the ion exchange performance lowers, and the glass composition loses its component balance, with the result that the glass is liable to devitrify to the worse. The content of SrO is preferably 0 to 5%, 0 to 3%, 0 to 1%, particularly preferably 0 to 0.1%.

BaO is a component that reduces the viscosity at high temperature to increase the meltability and formability, and increases the strain point and Young's modulus without causing any reduction in devitrification resistance. When the content of BaO is too large, the density and thermal expansion coefficient increase, the ion exchange performance lowers, and the glass composition loses its component balance, with the result that the glass is liable to devitrify to the worse. The content of BaO is preferably 0 to 5%, 0 to 3%, 0 to 1%, particularly preferably 0 to 0.1%.

TiO₂ is a component that enhances the ion exchange performance and is a component that reduces the viscosity at high temperature. However, when the content of TiO₂ is too large, the glass is liable to be colored and to devitrify. Thus, the content of TiO₂ is preferably 0 to 3%, 0 to 1%, 0 to 0.8%, 0 to 0.5%, particularly preferably 0 to 0.1%.

ZrO₂ is a component that remarkably enhances the ion exchange performance, and is a component that increases the viscosity around the liquidus viscosity and the strain point. However, when the content of ZrO₂ is too large, the devitrification resistance may lower remarkably and the density may increase excessively. Thus, the upper limit range of ZrO₂ is suitably 10% or less, 8% or less, 6% or less, 4% or less, particularly suitably 3% or less. Note that, when the enhancement of the ion exchange performance is intended, ZrO₂ is preferably added to the glass composition, and in this case, the lower limit range of ZrO₂ is suitably 0.01% or more, 0.1% or more, 0.5% or more, 1% or more, particularly suitably 2% or more.

ZnO is a component that enhances the ion exchange performance and is a component that has a great effect of increasing the compression stress value, in particular. Further, ZnO is a component that reduces the viscosity at high temperature without reducing the viscosity at low temperature. However, when the content of ZnO is too large, the glass manifests phase separation, the devitrification resistance lowers, the density increases, and the depth of the compression stress layer tends to decrease. Thus, the content of ZnO is preferably 0 to 6%, 0 to 5%, 0 to 3%, 0 to 1%, particularly preferably 0 to 0.5%.

As a fining agent, one kind or two or more kinds selected from the group consisting of As₂O₃, Sb₂O₃, CeO₂, SnO₂, F, Cl, and SO₃ (preferably the group consisting of SnO₂, Cl, and SO₃) may be added at 0 to 3%. The content of SnO₂+SO₃+Cl is preferably 0 to 1%, 100 to 3,000 ppm, 300 to 2,500 ppm, particularly preferably 500 to 2,500 ppm. Note that, when the content of SnO₂+SO₃+Cl is less than 100 ppm, it is difficult to obtain a fining effect. Herein, the “SnO₂+SO₃+Cl” refers to the total amount of SnO₂, SO₃, and Cl.

The tempered glass preferably contains As₂O₃, Sb₂O₃, and F as little as possible, and is more preferably substantially free of As₂O₃, Sb₂O₃, and F from the standpoint of environmental considerations. Herein, the gist of the phrase “substantially free of As₂O₃” resides in that As₂O₃ is not added positively as a glass component, but contamination with As₂O₃ as an impurity is allowable. Specifically, the phrase means that the content of As₂O₃ is less than 500 ppm (by mass). The gist of the phrase “substantially free of Sb₂O₃” resides in that Sb₂O₃ is not added positively as a glass component, but contamination with Sb₂O₃ as an impurity is allowable. Specifically, the phrase means that the content of Sb₂O₃ is less than 500 ppm (by mass). The gist of the phrase “substantially free of F” resides in that F is not added positively as a glass component, but contamination with F as an impurity is allowable. Specifically, the phrase means that the content of F is less than 500 ppm (by mass).

The content of Fe₂O₃ is preferably less than 500 ppm, less than 400 ppm, less than 300 ppm, less than 200 ppm, particularly preferably less than 150 ppm. With this, the transmittance (400 nm to 770 nm) of glass having a thickness of 1 mm is easily improved (for example, 90% or more).

A rare earth oxide such as Nb₂O₅ or La₂O₃ is a component that increases the Young's modulus. However, the cost of the raw material itself is high, and when the rare earth oxide is added in a large amount, the denitrification resistance is liable to lower. Thus, the content of the rare earth oxide is preferably 3% or less, 2% or less, 1% or less, 0.5% or less, particularly preferably 0.1% or less.

A transition metal element (such as Co or Ni) may reduce the transmittance of glass because the element causes the intense coloration of the glass. In particular, in the case where the glass is used for a touch panel display, when the content of the transition metal element is too large, the visibility of the touch panel display is liable to lower. Thus, it is preferred to select a glass raw material (including cullet) so that the content of a transition metal oxide is 0.5% or less, 0.1% or less, particularly 0.05% or less.

The tempered glass is preferably substantially free of PbO and Bi₂O₃ from environmental considerations. Herein, the gist of the phrase “substantially free of PbO” resides in that PbO is not added positively as a glass component, but contamination with PbO as an impurity is allowable. Specifically, the phrase means that the content of PbO is less than 500 ppm (by mass). The gist of the phrase “substantially free of Bi₂O₃” resides in that Bi₂O₃ is not added positively as a glass component, but contamination with Bi₂O₃ as an impurity is allowable. Specifically, the phrase means that the content of Bi₂O₃ is less than 500 ppm (by mass).

It is possible to construct suitable glass composition ranges by appropriately selecting suitable content ranges of the respective components. Of those, as a particularly suitable glass composition range, the tempered glass comprises, in terms of mol %, 50 to 70% of SiO₂, 5.5 to 9% of Al₂O₃, 0 to 0.1% of B₂O₃, 0 to 0.5% of Li₂O, 12 to 17% of Na₂O, 2 to 5% of K₂O, 0 to 12% of MgO, 0 to 2.5% of CaO, and 5 to 11% of MgO+CaO, and has a molar ratio (Al₂O₃+Na₂O+P₂O₅)/SiO₂ of 0.25 to 0.5, a molar ratio (B₂O₃+Na₂O)/SiO₂ of 0.15 to 0.27, a molar ratio P₂O₅/SiO₂ of 0 to 0.1, a molar ratio Al₂O₃/SiO₂ of 0.07 to 0.2, and a molar ratio Na₂O/Al₂O₃ of 1.2 to 2.3.

When the tempered glass of this embodiment is immersed in a 10-mass % HCl aqueous solution at 80° C. for 24 hours, the tempered glass preferably has a weight loss of 0.05 to 50 g/cm². When the value of the weight loss of a tempered glass is less than 0.05 g/cm², the rate of etching with respect to the tempered glass is low, and hence, even if the tempered glass having a large size is subjected to patterning to form a touch panel sensor or the like and to predetermined masking, followed by etching in an etching liquid, it is difficult to produce individual pieces each having a desired shape. On the other hand, when the value of the weight loss of a tempered glass is more than 50 g/cm², the rate of etching with an acid such as HCl with respect to the tempered glass is too high, and hence the resultant pieces are difficult to have desired surface quality and desired end surface quality. Note that the lower limit range of the weight loss is suitably 0.1 g/cm² or more, particularly suitably 0.2 g/cm² or more. Further, the upper limit range of the weight loss is suitably 45 g/cm² or less, 20 g/cm² or less, 10 g/cm² or less, 5 g/cm² or less, 2 g/cm² or less, particularly suitably 1 g/cm² or less.

The compression stress value of the compression stress layer of the tempered glass of this embodiment is preferably 300 MPa or more, 400 MPa or more, 500 MPa or more, 600 MPa or more, 700 MPa or more, particularly preferably 800 MPa or more. As the compression stress value becomes larger, the mechanical strength of the tempered glass becomes higher. On the other hand, when an extremely large compression stress is formed on the surface of the tempered glass, micro cracks are generated on the surface, which may reduce the mechanical strength of the tempered glass to the worse. Further, a tensile stress inherent in the tempered glass may extremely increase. Thus, the compression stress value of the compression stress layer is preferably 1,500 MPa or less. Note that there is a tendency that the compression stress value is increased by increasing the content of Al₂O₃, TiO₂, ZrO₂, MgO, or ZnO in the glass composition or by reducing the content of SrO or BaO in the glass composition. Further, there is a tendency that the compression stress value is increased by shortening a time necessary for ion exchange or by decreasing the temperature of an ion exchange solution.

The depth of the compression stress layer is preferably 10 μm or more, 15 μm or more, 20 μm or more, particularly preferably 25 μm or more. As the depth of the compression stress layer becomes larger, the tempered glass is more hardly cracked even when the tempered glass has a deep flaw, and a variation in mechanical strength of the tempered glass becomes smaller. On the other hand, as the depth of the compression stress layer becomes larger, it becomes more difficult to cut the tempered glass and masked parts of the tempered glass may break at the time of etching. Thus, the depth of the compression stress layer is preferably 500 μm or less, 200 μm or less, 150 μm or less, 90 μm or less, 60 μm or less, 50 μm or less, 40 μm or less, 35 μm or less, particularly preferably 30 μm or less. Note that there is a tendency that the depth of the compression stress layer is increased by increasing the content of K₂O or P₂O₅ in the glass composition or by decreasing the content of SrO or BaO in the glass composition. Further, there is a tendency that the depth of the compression stress layer is increased by lengthening a time necessary for ion exchange or by increasing the temperature of an ion exchange solution.

The internal tensile stress of the tempered glass is preferably 200 MPa or less, 150 MPa or less, 120 MPa or less, 100 MPa or less, 70 MPa or less, 50 MPa or less, 30 MPa or less, 25 MPa or less, particularly preferably 22 MPa or less. As the internal tensile stress of a tempered glass is larger, masked parts of the tempered glass may break at the time of etching. However, when the internal tensile stress of a tempered glass is extremely small, the compression stress value of its compression stress layer and the thickness thereof reduce. Thus, the internal tensile stress is preferably 1 MPa or more, 5 MPa or more, 10 MPa or more, 15 MPa or more.

The tempered glass of this embodiment has a density of preferably 2.6 g/cm³ or less, particularly preferably 2.55 g/cm³ or less. As the density becomes smaller, the weight of the tempered glass can be reduced more. Note that the density is easily reduced by increasing the content of SiO₂, B₂O₃, or P₂O₅ in the glass composition or by reducing the content of an alkali metal oxide, an alkaline earth metal oxide, ZnO, ZrO₂, or TiO₂ in the glass composition.

The tempered glass of this embodiment has a thermal expansion coefficient of preferably 80 to 120×10⁻⁷/° C., 85 to 110×10⁻⁷/° C., 90 to 110×10⁻⁷/° C., particularly preferably 90 to 105×10⁻⁷/° C. When the thermal expansion coefficient is controlled within the above-mentioned ranges, it becomes easy to match the thermal expansion coefficient with those of members made of a metal, an organic adhesive, and the like, and the members made of a metal, an organic adhesive, and the like are easily prevented from being peeled off. Herein, the “thermal expansion coefficient” refers to a value obtained through measurement of an average thermal expansion coefficient in the temperature range of 30 to 380° C. with a dilatometer. Note that the thermal expansion coefficient is easily increased by increasing the content of an alkali metal oxide or an alkaline earth metal oxide in the glass composition, and in contrast, the thermal expansion coefficient is easily decreased by reducing the content of the alkali metal oxide or the alkaline earth metal oxide.

The tempered glass of this embodiment has a strain point of preferably 500° C. or more, 520° C. or more, 530° C. or more, 550° C. or more, particularly preferably 570° C. or more. As the strain point becomes higher, the heat resistance is improved more, and the disappearance of the compression stress layer more hardly occurs when the tempered glass is subjected to thermal treatment. Further, as the strain point becomes higher, stress relaxation more hardly occurs during ion exchange treatment, and thus the compression stress value can be maintained more easily. Further, a high-quality film can be easily formed in patterning to form a touch panel sensor or the like. Note that the strain point is easily increased by increasing the content of an alkaline earth metal oxide, Al₂O₃, ZrO₂, or P₂O₅ in the glass composition or by reducing the content of an alkali metal oxide in the glass composition.

The tempered glass of this embodiment has a temperature at 10^{4.0} dPa·s of preferably 1,280° C. or less, 1,230° C. or less, 1,200° C. or less, 1,180° C. or less, particularly preferably 1,160° C. or less. As the temperature at 10^{4.0} dPa·s becomes lower, a burden on forming equipment is reduced more, the forming equipment has a longer life, and consequently, the production cost of the tempered glass is more likely to be reduced. Note that the temperature at 10^{4.0} dPa·s is easily decreased by increasing the content of an alkali metal oxide, an alkaline earth metal oxide, ZnO, B₂O₃, or TiO₂ or by reducing the content of SiO₂ or Al₂O₃.

The tempered glass of this embodiment has a temperature at 10^{2.5} dPa·s of preferably 1,620° C. or less, 1,550° C. or less, 1,530° C. or less, 1,500° C. or less, particularly preferably 1,450° C. or less. As the temperature at 10^{2.5} dPa·s becomes lower, melting at lower temperature can be carried out, and hence a burden on glass production equipment such as a melting furnace is reduced more, and the bubble quality is easily improved more. That is, as the temperature at 10^{2.5} dPa·s becomes lower, the production cost of the tempered glass is more likely to be reduced. Note that the temperature at 10^{2.5} dPa·s corresponds to a melting temperature. Further, the temperature at 10^{2.5} dPa·s is easily decreased by increasing the content of an alkali metal oxide, an alkaline earth metal oxide, ZnO, B₂O₃, or TiO₂ in the glass composition or by reducing the content of SiO₂ or Al₂O₃ in the glass composition.

The tempered glass of this embodiment has a liquidus temperature of preferably 1,200° C. or less, 1,150° C. or less, 1,100° C. or less, 1,050° C. or less, 1,000° C. or less, 950° C. or less, 900° C. or less, particularly preferably 880° C. or less. Note that as the liquidus temperature becomes lower, the denitrification resistance and formability are improved more. Further, the liquidus temperature is easily decreased by increasing the content of Na₂O, K₂O, or B₂O₃ in the glass composition or by reducing the content of Al₂O₃, Li₂O, MgO, ZnO, TiO₂, or ZrO₂ in the glass composition.

The tempered glass of this embodiment has a liquidus viscosity of preferably 10^{4.0} dPa·s or more, 10^{4.4} dPa·s or more, 10^{4.8} dPa·s or more, 10^{5.0} dPa·s or more, 10^{5.4} dPa·s or more, 10^{5.6} dPa·s or more, 10^{6.0} dPa·s or more, 10^{6.2} dPa·s or more, particularly preferably 10^{6.3} dPa·s or more. Note that, as the liquidus viscosity becomes higher, the denitrification resistance and formability are improved more. Further, the liquidus viscosity is easily increased by increasing the content of Na₂O or K₂O in the glass composition or by reducing the content of Al₂O₃, Li₂O, MgO, ZnO, TiO₂, or ZrO₂ in the glass composition.

The tempered glass of this embodiment has a surface roughness Ra of surfaces of excluding etched surfaces of preferably 1 nm or less, 0.5 nm or less, 0.3 nm or less, particularly preferably 0.2 nm or less. When the surface roughness Ra of the surfaces excluding the etched surfaces is too large, not only the appearance quality of the tempered glass deteriorates but also the mechanical strength thereof may deteriorate.

The tempered glass of this embodiment has a surface roughness Ra of the etched surfaces (the surface and the end surfaces) of preferably 1 nm or less, 0.5 nm or less, 0.3 nm or less, particularly preferably 0.2 nm or less. When the surface roughness Ra of the etched surfaces is too large, not only the appearance quality of the tempered glass deteriorates but also the mechanical strength thereof may deteriorate.

The tempered glass of this embodiment has a thickness (sheet thickness in the case of a sheet shape) of preferably 3.0 mm or less, 2.0 mm or less, 1.5 mm or less, 1.3 mm or less, 1.1 mm or less, 1.0 mm or less, 0.8 mm or less, particularly preferably 0.7 mm or less. On the other hand, when the thickness is too small, a desired mechanical strength is hardly provided. Thus, the thickness is preferably 0.1 mm or more, 0.2 mm or more, 0.3 mm or more, particularly preferably 0.4 mm or more.

(2) Glass to be Tempered

A glass to be tempered according to an embodiment of the present invention is characterized by comprising, as a glass composition in terms of mol %, 45 to 75% of SiO₂, 3 to 15% of Al₂O₃, 0 to 12% of B₂O₃, 0 to 12% of Li₂O, 0.3 to 20% of Na₂O, 0 to 10% of K₂O, 1 to 15% of MgO+CaO, and 0 to 10% of P₂O₅, and having a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5. Herein, the term “glass to be tempered” refers to a glass before tempering treatment (untempered glass). The technical features of the glass to be tempered are the same as those of the tempered glass described above. Herein, the description thereof is omitted for convenience sake.

When the glass to be tempered of this embodiment is immersed in a KNO₃ molten salt at 430° C. for 4 hours, it is preferred that the compression stress value of a compression stress layer in a surface thereof be 300 MPa or more and the depth of the compression stress layer be 10 μm or more, it is more preferred that the compression stress of the surface thereof be 600 MPa or more and the depth of the compression stress layer be 15 μm or more, and it is still more preferred that the compression stress of the surface thereof be 700 MPa or more and the depth of the compression stress layer be 20 μm or more.

When ion exchange treatment is performed, the temperature of the KNO₃ molten salt is preferably 400 to 550° C., and the ion exchange time is preferably 2 to 10 hours, particularly preferably 4 to 8 hours. With this, the compression stress layer can be properly formed easily. Note that the glass to be tempered of this embodiment has the above-mentioned glass composition, and hence the compression stress value and depth of the compression stress layer can be increased without using a mixture of a KNO₃ molten salt and an NaNO₃ molten salt or the like.

When the glass to be tempered of this embodiment is treated in a 5-mass % HF aqueous solution at 25° C. for 10 minutes, the surface roughness Ra of the etched surfaces is preferably 1 nm or less, 0.5 nm or less, 0.3 nm or less, particularly preferably 0.2 nm or less. When the surface roughness Ra of the etched surfaces is too large, not only the appearance quality of the tempered glass deteriorates but also the mechanical strength thereof may deteriorate.

When the glass to be tempered of this embodiment is immersed in a 10-mass % HCl aqueous solution at 80° C. for 24 hours, the glass to be tempered preferably has a weight loss of 0.05 to 50 g/cm³. When the weight loss is excessively small, the rate of etching is low and hence the productivity of the device is liable to lower. On the other hand, when the weight loss is excessively large, the rate of etching with an acid such as HCl is too high, and hence the glass is difficult to have desired surface quality and desired end surface quality. The lower limit range of the weight loss is suitably 0.1 g/cm² or more, particularly suitably 0.2 g/cm² or more. Further, the upper limit range of the weight loss is suitably 45 g/cm² or less, 20 g/cm² or less, 10 g/cm² or less, 5 g/cm² or less, 2 g/cm² or less, particularly suitably 1 g/cm² or less.

(3) Tempered Glass and Production for Tempered Glass

The above-mentioned glass to be tempered and tempered glass can be produced, for example, in the following manner.

First, glass raw materials blended so as to have the above-mentioned glass composition are loaded into a continuous melting furnace, melted under heating at 1,500 to 1,600° C., and fined. After that, the molten glass is cast into a forming apparatus to form a sheet-shaped glass or the like, followed by annealing. Thus, a glass to be tempered having a sheet shape or the like can be produced.

A float method is preferably adopted as a method of forming molten glass into a sheet-shaped glass. The float method is advantageous for mass production and upsizing.

Any of various forming methods except the float method may be adopted. It is possible to adopt a forming method such as an overflow down-draw method, a down-draw method (such as a slot down method or a re-draw method), a roll out method, or a press method.

Next, the resultant glass to be tempered can be subjected to tempering treatment to produce a tempered glass. When the tempered glass is processed into pieces each having a shape with a predetermined size, it is preferred, from the viewpoint of better productivity, that a large glass sheet be subjected to tempering treatment, and the resultant tempered glass sheet be then subjected to patterning to form a touch panel sensor or the like and to predetermined masking, followed by etching in an etching liquid, thereby producing individual pieces each having a desired shape.

Ion exchange treatment is preferably used as the tempering treatment. Conditions for the ion exchange treatment are not particularly limited, and optimum conditions may be selected in view of, for example, the viscosity properties, applications, thickness, and internal tensile stress of glass. The ion exchange treatment can be performed, for example, by immersing the glass to be tempered in a KNO₃ molten salt at 400 to 550° C. for 1 to 8 hours. Particularly when the ion exchange of K ions in the KNO₃ molten salt with Na components in the glass is performed, it is possible to form efficiently a compression stress layer.

Next, it is preferred that part of the surface of the resultant tempered glass be subjected to masking so as to have a desired shape (shape necessary to be used in a protective member for a cellular phone, a tablet PC, or the like), followed by etching in an etching liquid. The etching liquid is preferably an etching liquid comprising one kind or two or more kinds selected from the group consisting of HF, HCl, H₂SO₄, HNO₃, NH₄F, NaOH, and NH₄HF₂, in particular, one kind or two or more kinds selected from the group consisting of HCl, HF, and HNO₃. An aqueous solution having a concentration of preferably 1 to 20 mass %, 2 to 10 mass %, particularly preferably 3 to 8 mass % is used as the etching liquid. The temperature of the etching liquid used is preferably 20 to 50° C., 20 to 40° C., 20 to 30° C., except for the case of using HF. The time of the etching is preferably 1 to 20 minutes, 2 to 15 minutes, particularly preferably 3 to 10 minutes. When such etching is performed, a desired shape can be provided without the performance of a cutting process, an end surface process, a drilling process, and the like after tempering treatment. In this case, it is preferred that the tempered glass be separated into a plurality of small pieces.

Note that the step of patterning on a surface of the tempered glass may be performed before the performance of the step of masking the tempered glass. With this, patterning can be collectively applied onto the small pieces to be obtained, which can contribute to decreasing the production cost of a device using the tempered glass.

### EXAMPLES

### Example 1

Hereinafter, examples of the present invention are described. Note that the following examples are merely illustrative. The present invention is by no means limited to the following examples.

Tables 1 to 3 show Examples of the present invention (Samples Nos. 1 to 21). Note that, in the tables, the term “Not measured” means that measurement has not yet been performed.

TABLE 1

| | | Examples | | | | | | |
|---|---|---|---|---|---|---|---|---|
| | | No. 1 | No. 2 | No. 3 | No. 4 | No. 5 | No. 6 | No. 7 |
| Glass | SiO₂ | 61.1 | 60.3 | 61.6 | 61.4 | 61.1 | 57.4 | 58.7 |
| composition | Al₂O₃ | 12.9 | 13.0 | 9.8 | 11.0 | 12.3 | 13.3 | 13.1 |
| (mol %) | MgO | 6.5 | 6.6 | 6.6 | 6.6 | 6.5 | 6.7 | 6.7 |
| | CaO | — | — | — | — | — | — | — |
| | B₂O₃ | — | — | — | — | — | — | — |
| | ZrO₂ | — | — | — | — | — | 1.1 | 1.1 |
| | Li₂O | — | — | — | — | — | — | — |
| | Na₂O | 15.9 | 16.0 | 16.1 | 16.0 | 16.0 | 16.4 | 16.2 |
| | K₂O | 3.5 | 3.5 | 3.5 | 3.5 | 3.5 | 3.6 | 3.6 |
| | P₂O₅ | — | 0.5 | 2.3 | 1.4 | 0.5 | 1.4 | 0.5 |
| | SnO₂ | — | 0.1 | 0.1 | 0.1 | 0.1 | 0.1 | 0.1 |
| | SO₃ | 0.03 | — | — | — | — | — | — |
| | Cl | 0.07 | — | — | — | — | — | — |

| | | | | | | | |
|---|---|---|---|---|---|---|---|
| Mg + Ca | 6.5 | 6.6 | 6.6 | 6.6 | 6.5 | 6.7 | 6.6 |
| (Al + Na + P)/Si | 0.5 | 0.5 | 0.5 | 0.5 | 0.5 | 0.5 | 0.5 |
| (B + Na)/Si | 0.26 | 0.27 | 0.26 | 0.26 | 0.26 | 0.29 | 0.28 |
| P/Si | 0 | 0.008 | 0.038 | 0.023 | 0.008 | 0.025 | 0.008 |
| Al/Si | 0.2 | 0.2 | 0.2 | 0.2 | 0.2 | 0.2 | 0.2 |
| Na/Al | 1.2 | 1.2 | 1.6 | 1.5 | 1.3 | 1.2 | 1.2 |
| ρ (g/cm³) | 2.47 | 2.48 | 2.46 | 2.47 | 2.47 | 2.51 | 2.51 |
| α (×10⁻⁷/° C.) | 102 | 102 | 110 | 105 | 103 | 104 | 101 |
| Ps (° C.) | 585 | 584 | 553 | 553 | 575 | 600 | 602 |
| Ta (° C.) | 634 | 832 | 602 | 600 | 623 | 648 | 651 |
| Ts (° C.) | 866 | 865 | 855 | 833 | 854 | 876 | 879 |
| 10^{4.0} dPa · s (° C.) | 1,225 | 1,226 | 1,176 | 1,197 | 1,214 | 1,214 | 1,219 |
| 10^{3.0} dPa · s (° C.) | 1,412 | 1,412 | 1,369 | 1,388 | 1,400 | 1,388 | 1,395 |
| 10^{2.5} dPa · s (° C.) | 1,528 | 1,529 | 1,489 | 1,507 | 1,515 | 1,497 | 1,505 |
| TL (° C.) | 1,150 | 1,150 | 1,090 | 1,040 | 1,120 | 1,088 | 1,140 |
| log₁₀η_{TL} (dPa · s) | 4.5 | 4.3 | 4.7 | 5.2 | 4.7 | 5.0 | 4.6 |
| CS (MPa) | 1,035 | 1,007 | 772 | 822 | 939 | 1,102 | 1,115 |
| DOL (μm) | 19 | 20 | 23 | 21 | 20 | 20 | 18 |
| Internal tensile | 25 | 26 | 23 | 23 | 25 | 28 | 27 |
| stress (MPa) | | | | | | | |
| Weight loss caused | 40.1 | 40.2 | 0.4 | 17.7 | Not | Not | Not |
| by HCl (g/cm²) | | | | | measured | measured | measured |

TABLE 2

| | | Examples | | | | | | |
|---|---|---|---|---|---|---|---|---|
| | | No. 8 | No. 9 | No. 10 | No. 11 | No. 12 | No. 13 | No. 14 |
| Glass | SiO₂ | 60.4 | 65.0 | 64.2 | 63.5 | 62.9 | 62.3 | 60.7 |
| composition | Al₂O₃ | 11.7 | 9.5 | 10.2 | 10.8 | 9.7 | 10.3 | 10.5 |
| (mol %) | MgO | 6.6 | 6.4 | 6.4 | 6.4 | 6.5 | 6.5 | 6.6 |
| | CaO | — | — | — | — | — | — | — |
| | B₂O₃ | — | — | — | — | — | — | — |
| | ZrO₂ | 1.1 | — | — | — | — | — | — |
| | Li₂O | — | — | — | — | — | — | — |
| | Na₂O | 16.1 | 15.6 | 15.7 | 15.7 | 15.9 | 15.9 | 16.2 |
| | K₂O | 3.5 | 3.4 | 3.4 | 3.5 | 3.5 | 3.5 | 3.5 |
| | P₂O₅ | 0.5 | — | — | — | 1.4 | 1.4 | 2.4 |
| | SnO₂ | 0.1 | — | — | — | 0.1 | 0.1 | 0.1 |
| | SO₃ | — | 0.07 | 0.01 | — | — | — | — |
| | Cl | — | 0.03 | 0.09 | 0.10 | — | — | — |

| | | | | | | | |
|---|---|---|---|---|---|---|---|
| Mg + Ca | 6.6 | 6.4 | 6.4 | 6.4 | 6.5 | 6.5 | 6.6 |
| (Al + Na + P)/Si | 0.5 | 0.4 | 0.4 | 0.4 | 0.4 | 0.4 | 0.5 |
| (B + Na)/Si | 0.27 | 0.24 | 0.24 | 0.25 | 0.25 | 0.26 | 0.27 |
| P/Si | 0.008 | 0 | 0 | 0 | 0.022 | 0.022 | 0.039 |
| Al/Si | 0.2 | 0.1 | 0.2 | 0.2 | 0.2 | 0.2 | 0.2 |
| Na/Al | 1.4 | 1.6 | 1.5 | 1.5 | 1.6 | 1.5 | 1.5 |
| ρ (g/cm³) | 2.50 | 2.46 | 2.46 | 2.46 | 2.46 | 2.46 | 2.46 |
| α (×10⁻⁷/° C.) | 101 | 101 | 102 | 102 | 103 | 103 | 110 |
| Ps (° C.) | 586 | 540 | 548 | 558 | 541 | 549 | 564 |
| Ta (° C.) | 634 | 585 | 595 | 606 | 587 | 596 | 614 |
| Ts (° C.) | 862 | 811 | 822 | 834 | 824 | 832 | 868 |
| 10^{4.0} dPa · s (° C.) | 1,208 | 1,182 | 1,192 | 1,203 | 1,182 | 1,189 | 1,189 |
| 10^{3.0} dPa · s (° C.) | 1,387 | 1,380 | 1,387 | 1,398 | 1,376 | 1,381 | 1,379 |
| 10^{2.5} dPa · s (° C.) | 1,500 | 1,505 | 1,510 | 1,522 | 1,499 | 1,504 | 1,498 |
| TL (° C.) | 1,080 | Not | 980 | 1,000 | 1,110 | 1,050 | Not |
| | | measured | | | | | measured |
| log₁₀η_{TL} (dPa · s) | 5.0 | Not | 5.7 | 5.6 | 4.5 | 5.0 | Not |
| | | measured | | | | | measured |
| CS (MPa) | 1,031 | 882 | 757 | 769 | 870 | 826 | 852 |
| DOL (μm) | 19 | 19 | 21 | 19 | 18 | 21 | 22 |
| Internal tensile | 25 | 22 | 21 | 19 | 21 | 22 | 25 |
| stress (MPa) | | | | | | | |
| Weight loss caused | Not | Not | 0.52 | 0.12 | 0.45 | 1.02 | 0.55 |
| by HCl (g/cm²) | measured | measured | | | | | |

TABLE 3

| | | Examples | | | | | | |
|---|---|---|---|---|---|---|---|---|
| | | No. 15 | No. 16 | No. 17 | No. 18 | No. 19 | No. 20 | No. 21 |
| Glass | SiO₂ | 59.8 | 61.4 | 62.6 | 61.1 | 65.8 | 62.1 | 63.92 |
| composition | Al₂O₃ | 11.2 | 9.8 | 11.5 | 11.6 | 10.6 | 11.4 | 8.4 |
| (mol %) | MgO | 6.7 | 6.6 | 6.5 | 6.6 | 4.7 | 6.6 | 3.3 |
| | CaO | — | — | — | — | — | — | 2.4 |
| | B₂O₃ | — | — | — | — | 0.6 | — | — |
| | ZrO₂ | — | 1.1 | — | 1.1 | — | — | 2.4 |
| | Li₂O | — | — | — | — | — | — | 0.2 |
| | Na₂O | 16.2 | 16.1 | 15.8 | 16.0 | 13.3 | 15.0 | 15.4 |
| | K₂O | 3.6 | 3.5 | 3.5 | 3.5 | 2.7 | 3.5 | 3.9 |
| | P₂O₅ | 2.4 | 1.4 | — | — | 2.2 | 1.4 | — |
| | SnO₂ | 0.1 | 0.1 | — | — | 0.1 | — | — |
| | SO₃ | — | — | 0.05 | 0.08 | — | — | 0.08 |
| | Cl | — | — | 0.05 | 0.02 | — | — | — |

| | | | | | | | |
|---|---|---|---|---|---|---|---|
| Mg + Ca | 6.7 | 6.6 | 6.5 | 6.5 | 4.7 | 6.6 | 5.6 |
| (Al + Na + P)/Si | 0.5 | 0.4 | 0.4 | 0.5 | 0.4 | 0.4 | 0.37 |
| (B + Na)/Si | 0.27 | 0.26 | 0.25 | 0.26 | 0.21 | 0.24 | 0.24 |
| P/Si | 0.039 | 0.023 | 0 | 0 | 0.034 | 0.023 | 0.001 |
| Al/Si | 0.2 | 0.2 | 0.2 | 0.2 | 0.2 | 0.2 | 0.13 |
| Na/Al | 1.5 | 1.6 | 1.4 | 1.4 | 1.3 | 1.3 | 1.83 |
| ρ (g/cm³) | 2.46 | 2.49 | 2.47 | 2.50 | 2.42 | 2.46 | 2.54 |
| α (×10⁻⁷/° C.) | 109 | 102 | 102 | 103 | 93 | 102 | 102 |
| Ps (° C.) | 574 | 562 | 567 | 586 | 585 | 570 | 533 |
| Ta (° C.) | 624 | 610 | 614 | 635 | 639 | 619 | 576 |
| Ts (° C.) | Not | 844 | 844 | 862 | 932 | 867 | 793 |
| | measured | | | | | | |
| 10^{4.0} dPa · s (° C.) | 1,193 | 1,183 | 1,208 | 1,209 | 1,280 | 1,227 | 1,142 |
| 10^{3.0} dPa · s (° C.) | 1,382 | 1,366 | 1,398 | 1,390 | 1,484 | 1,421 | 1,319 |
| 10^{2.5} dPa · s (° C.) | 1,500 | 1,482 | 1,517 | 1,505 | 1,612 | 1,542 | 1,431 |
| TL (° C.) | Not | Not | Not | Not | Not | Not | 880 |
| | measured | measured | measured | measured | measured | measured | |
| log₁₀η_{TL} (dPa · s) | Not | Not | Not | Not | Not | Not | 6.4 |
| | measured | measured | measured | measured | measured | measured | |
| CS (MPa) | 855 | 850 | 921 | 1,068 | 783 | 878 | 904 |
| DOL (μm) | 24 | 20 | 19 | 17 | 22 | 21 | 14 |
| Internal tensile | 27 | 22 | 23 | 24 | 23 | 24 | 16 |
| stress (MPa) | | | | | | | |
| Weight loss caused | Not | Not | Not | Not | Not | Not | 0.3 |
| by HCl (g/cm²) | measured | measured | measured | measured | measured | measured | |

Each of the samples in the tables was produced as described below. First, glass raw materials were blended so as to have glass compositions shown in the tables, and melted at 1,580° C. for 8 hours using a platinum pot. After that, the resultant molten glass was cast on a carbon plate and formed into a sheet shape. The resultant glass sheet was evaluated for its various properties. Note that a product processed into a glass sheet having a thickness of 0.8 mm was used as a sample for the measurement of tempering properties.

The density ρ is a value obtained through measurement by a well-known Archimedes method.

The thermal expansion coefficient α is a value obtained through measurement of an average thermal expansion coefficient in the temperature range of 30 to 380° C. using a dilatometer.

The strain point Ps and the annealing point Ta are values obtained through measurement based on a method of ASTM C336.

The softening point Ts is a value obtained through measurement based on a method of ASTM C338.

The temperatures at the high temperature viscosities of 10^{4.0} dPa·s, 10^{3.0} dPa·s, and 10^{2.5} dPa·s are values obtained through measurement by a platinum sphere pull up method.

The liquidus temperature TL is a value obtained through measurement of a temperature at which crystals of glass are deposited after glass powder that passes through a standard 30-mesh sieve (sieve opening: 500 μm) and remains on a 50-mesh sieve (sieve opening: 300 μm) is placed in a platinum boat and then kept for 24 hours in a gradient heating furnace.

The liquidus viscosity log₁₀η_{TL} is a value obtained through measurement of a viscosity of glass at the liquidus temperature by a platinum sphere pull up method.

The weight loss of glass caused by an HCl aqueous solution was evaluated as described below. First, each of the samples was processed into a strip shape measuring 20 mm by 50 mm by 1 mm and then sufficiently washed with isopropyl alcohol. Next, each of the resultant samples was dried and its mass was measured. Further, 100 ml of a 10-mass % HCl aqueous solution were prepared and were poured into a Teflon (trademark) bottle, and then the temperature was adjusted to 80° C. Subsequently, each of the samples after the drying was immersed in the 10-mass % HCl aqueous solution for 24 hours, whereby its surface and end surfaces were etched. Finally, the mass of each of the etched samples was measured, and then the weight loss of each of the samples was divided by the surface area thereof. Thus, the weight loss per unit area was calculated.

As evident from Tables 1 to 3, each of Samples Nos. 1 to 21 was found to be suitable as a material for a tempered glass, i.e., a glass to be tempered because each of the samples had a density ρ of 2.54 g/cm³ or less and a thermal expansion coefficient α of 93 to 110×10⁻⁷/° C. Further, each of Samples Nos. 1 to 21 has a liquidus viscosity log₁₀η_{TL} of 10^{4.3} dPa·s or more, and hence can be formed into a sheet shape. Further, each of the samples has a temperature at 10^{4.0} dPa·s of 1,280° C. or less, and hence does not impose a large burden on forming equipment. Moreover, each of the samples has a temperature at 10^{2.5} dPa·s of 1,612° C. or less, and hence is expected to allow a large number of glass sheets to be produced at low cost with high productivity. Note that the glass compositions in a surface layer before and after tempering treatment are different from each other microscopically, but the glass composition of the whole glass is not substantially changed before and after the tempering treatment.

Subsequently, both surfaces of each of the samples for the measurement of tempering properties were subjected to optical polishing, and then subjected to ion exchange treatment including immersion in a KNO₃ molten salt at 420° C. for 1.5 hours. Subsequently, after the ion exchange treatment, each of the samples was washed. Then, the stress compression value CS and thickness DOL of a compression stress layer were calculated from the number of interference fringes and each interval between the interference fringes, the interference fringes being observed with a surface stress meter (FSM-6000 manufactured by Toshiba Corporation). In the calculation, the refractive index and optical elastic constant of each of the measurement samples were set to 1.52 and 28 [(nm/cm)/MPa], respectively.

Further, the internal tensile stress of the tempered glass was calculated by using the following equation.

Internal tensile stress=(compression stress value×depth of compression stress layer)/(sheet thickness−depth of compression stress layer×2)

As evident from Tables 1 to 3, when each of Samples Nos. 1 to 21 was subjected to ion exchange treatment in a KNO₃ molten salt, the compression stress value CS of the compression stress layer was found to be 757 MPa or more, the thickness DOL was found to be 14 μm or more, and the internal tensile stress was found to be 16 to 28 MPa.

### Example 2

Glass raw materials blended so as to achieve the glass composition described in Sample No. 21 were fed into a continuous melting furnace and were melted under heating, followed by fining. After that, the resultant molten glass was formed into a glass sheet having a thickness of 0.8 mm by a float method. Subsequently, the glass sheet obtained was processed into a glass sheet having a size of 1 m by 1.2 m, and then ion exchange treatment was performed by immersing the sheet in a KNO₃ molten salt at 420° C. for 2 hours.

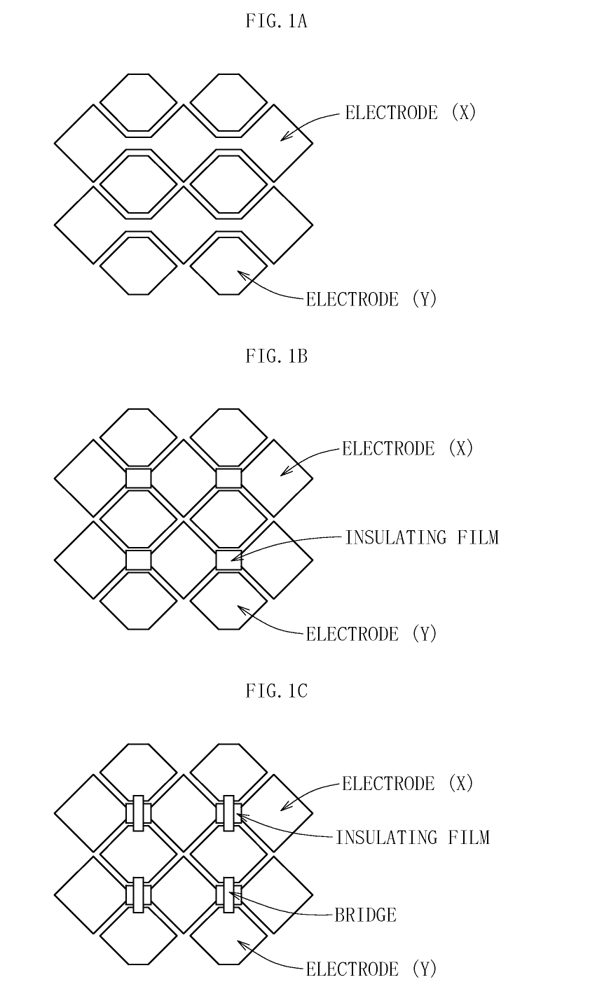

After a rectangular ITO patterning (for the XY directions) was performed as illustrated in FIG. 1A with respect to the resultant tempered glass, a patterning for forming an insulating film was performed as illustrated in FIG. 1B and a metal-film-bridge patterning (in the Y direction) was then performed as illustrated in FIG. 1C. Thus, a touch panel sensor was formed on the tempered glass.

Subsequently, masking with Au was performed so that each resultant glass piece measured 170 mm by 100 mm (R=7 mm at each corner part). Next, the tempered glass with the touch panel sensor and the Au masking was immersed in a 48-mass % HF aqueous solution (30° C.) for 30 minutes, yielding a plurality of tempered glass pieces. Further, the Au on each surface thereof was removed by etching. Thus, tempered glasses with a touch panel sensor were yielded.

The surface roughness Ra of a surface (surface on which no touch panel sensor was formed) of each of the tempered glass pieces yielded and the surface roughness Ra of each end surface thereof were measured. As a result, it was found that the surface roughness Ra of the surface was 0.0003 μm and the surface roughness Ra of the end surface was 0.0021 μm. Note that the term “surface roughness Ra” refers to a value obtained by a measurement method in accordance with SEMI D7-94 “FPD glass substrate surface roughness measurement method.”

### INDUSTRIAL APPLICABILITY

The tempered glass of the present invention is suitable for a cover glass for a cellular phone, a digital camera, a PDA, or the like, or a substrate for a touch panel display or the like. Further, the tempered glass of the present invention can be expected to find use in applications requiring a high mechanical strength, for example, a window glass, a substrate for a magnetic disk, a substrate for a flat panel display, a cover glass for a solar cell, a cover glass for a solid image pick-up element, and tableware, in addition to the above-mentioned applications.

1. A tempered glass having a compression stress layer in a surface thereof, the tempered glass comprising, as a glass composition in terms of mol %, 45 to 75% of SiO₂, 3 to 15% of Al₂O₃, 0 to 12% of B₂O₃, 0 to 12% of Li₂O, 0.3 to 20% of Na₂O, 0 to 10% of K₂O, 1 to 15% of MgO+CaO, and 0 to 10% of P₂O₅, and having a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5, wherein the surface or an end surface of the tempered glass is etched after tempering treatment.

2. The tempered glass according to claim 1, wherein the tempered glass comprises, as a glass composition in terms of mol %, 45 to 75% of SiO₂, 4 to 13% of Al₂O₃, 0 to 3% of B₂O₃, 0 to 8% of Li₂O, 5 to 20% of Na₂O, 0.1 to 10% of K₂O, 3 to 13% of MgO+CaO, and 0 to 10% of P₂O₅, and has a molar ratio (Al₂O₃+Na₂O+P₂O₅)/SiO₂ of 0.1 to 0.7, a molar ratio (B₂O₃+Na₂O)/SiO₂ of 0.1 to 0.7, a molar ratio P₂O₅/SiO₂ of 0 to 0.5, a molar ratio Al₂O₃/SiO₂ of 0.01 to 0.7, and a molar ratio Na₂O/Al₂O₃ of 0.5 to 4.

3. The tempered glass according to claim 1, wherein the tempered glass comprises, as a glass composition in terms of mol %, 45 to 75% of SiO₂, 5 to 12% of Al₂O₃, 0 to 1% of B₂O₃, 0 to 4% of Li₂O, 8 to 20% of Na₂O, 0.5 to 10% of K₂O, 5 to 13% of MgO+CaO, and 0 to 10% of P₂O₅, and has a molar ratio (Al₂O₃+Na₂O+P₂O₅)/SiO₂ of 0.1 to 0.5, a molar ratio (B₂O₃+Na₂O)/SiO₂ of 0.1 to 0.5, a molar ratio P₂O₅/SiO₂ of 0 to 0.3, a molar ratio Al₂O₃/SiO₂ of 0.05 to 0.5, and a molar ratio Na₂O/Al₂O₃ of 1 to 3.

4. The tempered glass according to claim 1, wherein the tempered glass comprises, as a glass composition in terms of mol %, 45 to 75% of SiO₂, 5 to 11% of Al₂O₃, 0 to 1% of B₂O₃, 0 to 4% of Li₂O, 9 to 20% of Na₂O, 0.5 to 8% of K₂O, 0 to 12% of MgO, 0 to 3% of CaO, 5 to 12% of MgO+CaO, and 0 to 10% of P₂O₅, and has a molar ratio (Al₂O₃+Na₂O+P₂O₅)/SiO₂ of 0.1 to 0.5, a molar ratio (B₂O₃+Na₂O)/SiO₂ of 0.1 to 0.3, a molar ratio P₂O₅/SiO₂ of 0 to 0.2, a molar ratio Al₂O₃/SiO₂ of 0.05 to 0.3, and a molar ratio Na₂O/Al₂O₃ of 1 to 3.

5. The tempered glass according to claim 1, wherein the tempered glass comprises, as a glass composition in terms of mol %, 50 to 70% of SiO₂, 5 to 11% of Al₂O₃, 0 to 1% of B₂O₃, 0 to 2% of Li₂O, 10 to 18% of Na₂₀, 1 to 6% of K₂O, 0 to 12% of MgO, 0 to 2.5% of CaO, 5 to 12% of MgO+CaO, and 0 to 10% of P₂O₅, and has a molar ratio (Al₂O₃+Na₂O+P₂O₅)/SiO₂ of 0.2 to 0.5, a molar ratio (B₂O₃+Na₂O)/SiO₂ of 0.15 to 0.27, a molar ratio P₂O₅/SiO₂ of 0 to 0.1, a molar ratio Al₂O₃/SiO₂ of 0.07 to 0.2, and a molar ratio Na₂O/Al₂O₃ of 1 to 2.3.

6. The tempered glass according to claim 1, wherein a surface roughness Ra of the etched surface is 1 nm or less.

7. The tempered glass according to claim 1, wherein a compression stress value of the compression stress layer is 200 MPa or more, and a depth of the compression stress layer is 10 μm or more.

8. The tempered glass according to claim 1, wherein the tempered glass has an internal tensile stress of 1 to 200 MPa.

9. The tempered glass according to claim 1, wherein the tempered glass has a liquidus temperature of 1,250° C. or less.

10. The tempered glass according to claim 1, wherein the tempered glass has a liquidus viscosity of 10^{4.0} dPa·s or more.

11. The tempered glass according to claim 1, wherein the tempered glass has a temperature at 10^{4.0} dPa·s of 1,280° C. or less.

12. The tempered glass according to claim 1, wherein the tempered glass has a temperature at 10^{2.5} dPa·s of 1,620° C. or less.

13. The tempered glass according to claim 1, wherein the tempered glass has a density of 2.6 g/cm³ or less.

14. The tempered glass according to claim 1, wherein the tempered glass is formed by a float method.

15. The tempered glass according to claim 1, wherein the tempered glass is used for a touch panel display.

16. The tempered glass according to claim 1, wherein the tempered glass is used for a cover glass for a cellular phone.

17-22. (canceled)

23. A production method for a tempered glass, comprising:
a forming step of melting glass raw materials blended to achieve a glass composition comprising, in terms of mol %, 45 to 75% of SiO₂, 3 to 15% of Al₂O₃, 0 to 12% of Li₂O, 0.3 to 20% of Na₂O, 0 to 10% of K₂O, and 1 to 15% of MgO+CaO, into molten glass, followed by formation of the molten glass into a glass sheet;
a tempering step of forming a compression stress layer by performing ion exchange treatment to yield a tempered glass;
a masking step of masking a surface of the tempered glass; and
an etching step of etching the tempered glass in an etching liquid.

24. The production method for a tempered glass according to claim 23, further comprising a patterning step of performing patterning on the surface of the tempered glass before the masking step.

25. The production method for a tempered glass according to claim 23, wherein the etching step comprises a step of separating the tempered glass into a plurality of small tempered glass pieces.

26. The production method for a tempered glass according to claim 23, wherein the etching liquid comprises one kind or two or more kinds selected from the group consisting of HF, HCl, H₂SO₄, HNO₃, NH₄F, NaOH, and NH₄HF₂.
